(19) United States
(12) Patent Application Publication
(10) Pub. No.: US 2015/0227269 A1
(43) Pub. Date: Aug. 13, 2015

(54) FAST RESPONSE GRAPHICAL USER INTERFACE

(71) Applicant: Charles J. Kulas, San Francisco, CA (US)

(72) Inventor: Charles J. Kulas, San Francisco, CA (US)

(21) Appl. No.: 14/616,493

(22) Filed: Feb. 6, 2015

Related U.S. Application Data
(60) Provisional application No. 61/937,351, filed on Feb. 7, 2014.

(51) Int. Cl. G06F 3/0482; G06F 3/0484

(52) U.S. Cl. CPC G06F 3/0482; G06F 3/04847

(57) ABSTRACT

Embodiments relate in general to computer graphical user interfaces and more specifically to improving the responsiveness of a user interface by allowing a user to skip through successive screens or displays while still achieving the intended function. One embodiment provides a method for providing a graphical user interface on a device, the method comprising: rendering a first screen on the device, wherein the first screen includes a first option, wherein selecting the option in a normal mode of operation causes the device to render a second display screen, wherein the second display screen includes a second option, wherein the second option corresponds to a function; selecting a second non-normal mode of operation; accepting a first user input to select the first option; skipping rendering of the second display screen; detecting a second user input that would have selected the second option on the second display screen had the second display screen been rendered; and performing the function in response to the second user input.

### CROSS REFERENCES TO RELATED APPLICATIONS

This application claims priority from U.S. Provisional Patent Application Ser. No. 61/937,351, entitled FAST RESPONSE GRAPHICAL USER INTERFACE, filed on Feb. 7, 2014, which is hereby incorporated by reference as if set forth in full in this application for all purposes.

### SUMMARY

Embodiments relate in general to computer graphical user interfaces and more specifically to improving the responsiveness of a user interface by allowing a user to skip through successive screens or displays while still achieving the intended function.

One embodiment provides a method for providing a graphical user interface on a device, the method comprising: rendering a first screen on the device, wherein the first screen includes a first option, wherein selecting the option in a normal mode of operation causes the device to render a second display screen, wherein the second display screen includes a second option, wherein the second option corresponds to a function; selecting a second non-normal mode of operation; accepting a first user input to select the first option; skipping rendering of the second display screen; detecting a second user input that would have selected the second option on the second display screen had the second display screen been rendered; and performing the function in response to the second user input.

Another embodiment provides an apparatus comprising: one or more processors; a processor-readable tangible medium including one or more instructions executable by the processor for providing a graphical user interface on a device, the processor-readable tangible medium including one or more instructions for: rendering a first screen on the device, wherein the first screen includes a first option, wherein selecting the option in a normal mode of operation causes the device to render a second display screen, wherein the second display screen includes a second option, wherein the second option corresponds to a function; selecting a second non-normal mode of operation; accepting a first user input to select the first option; skipping rendering of the second display screen; detecting a second user input that would have selected the second option on the second display screen had the second display screen been rendered; and performing the function in response to the second user input.

Another embodiment provides a processor-readable tangible medium including one or more instructions executable by the processor for providing a graphical user interface on a device, the processor-readable tangible medium including one or more instructions for: rendering a first screen on the device, wherein the first screen includes a first option, wherein selecting the option in a normal mode of operation causes the device to render a second display screen, wherein the second display screen includes a second option, wherein the second option corresponds to a function; selecting a second non-normal mode of operation; accepting a first user input to select the first option; skipping rendering of the second display screen; detecting a second user input that would have selected the second option on the second display screen had the second display screen been rendered; and performing the function in response to the second user input.

Another embodiment provides a method for controlling a device, the method comprising: recording two or more user inputs to create an action pattern; associating a function with the created action pattern; and determining when at least a portion of the created action pattern is being entered by a user; and performing the function in response to the determining.

Another embodiment provides an apparatus comprising: one or more processors; a processor-readable tangible medium including one or more instructions executable by the processor for controlling a device, the processor-readable tangible medium including one or more instructions for: recording two or more user inputs to create an action pattern; associating a function with the created action pattern; and determining when at least a portion of the created action pattern is being entered by a user; and performing the function in response to the determining.

Another embodiment provides a processor-readable tangible medium including one or more instructions executable by the processor for controlling a device, the processor-readable tangible medium including one or more instructions for: recording two or more user inputs to create an action pattern; associating a function with the created action pattern; determining when at least a portion of the created action pattern is being entered by a user; and performing the function in response to the determining.

Another embodiment provides a method for implementing a user interface on a device, the method comprising: using an action pattern to invoke a function.

Additional embodiments may be described herein.

### BRIEF DESCRIPTION OF THE DRAWINGS

FIGS. 1A-G illustrate a first use case to turn on a WiFi hotspot;

FIGS. 2A-C show combining user actions for an action pattern;

FIGS. 3A-F illustrate a second use case for calling a favorite contact;

FIG. 4 illustrates basic hardware suitable for use with embodiments of the invention; and

FIG. 5 is a flowchart showing basic steps in an embodiment.

### DESCRIPTION OF EMBODIMENTS

Embodiments relate in general to computer graphical user interfaces and more specifically to improving the responsiveness of a user interface by allowing a user to skip through successive screens or displays while still achieving the intended function.

Although specific “use cases” or operations are described, various features of embodiments of the invention can be applied to any function or action in a user interface.

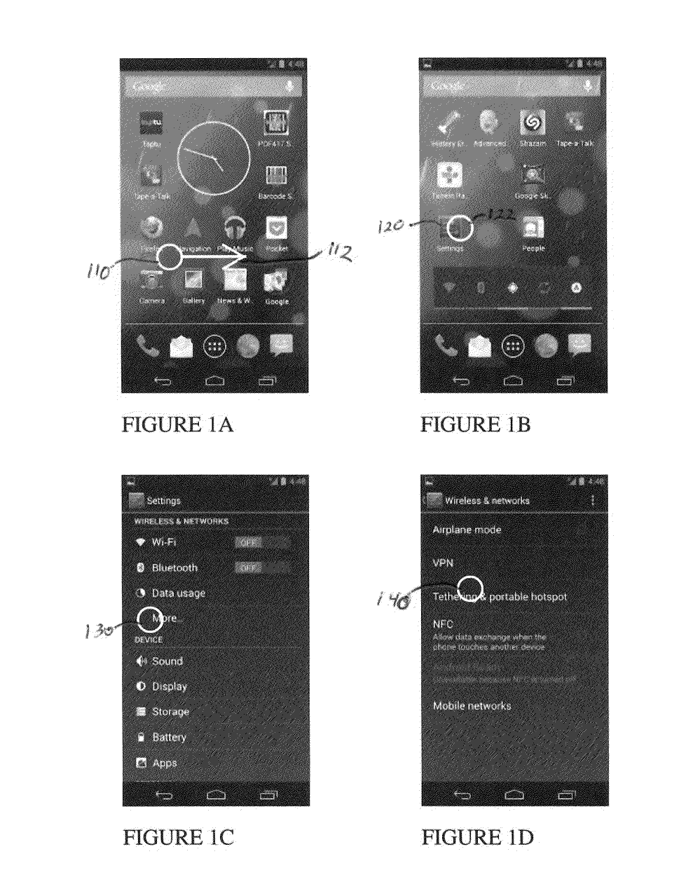

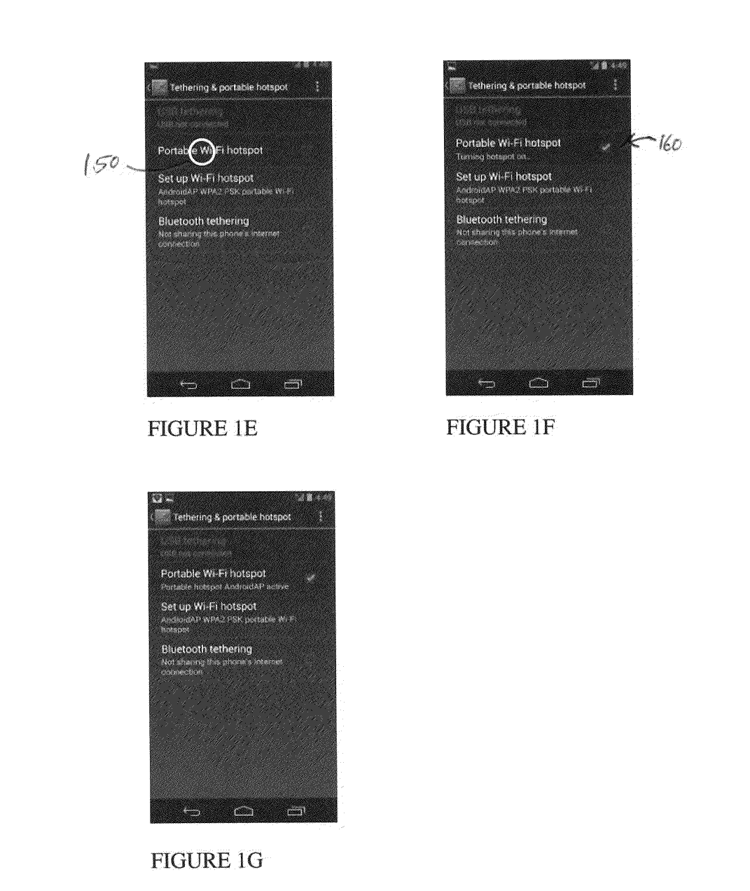

FIGS. 1A-G illustrate different screen displays in a sequence of operations to perform a function of activating a portable wifi hotspot. In this particular example, the screen displays are from a Samsung Galaxy Nexus that is running the Android operating system version 4.3. However, it should be apparent that features described herein can be adapted to any number and type of operating system, application or other functions or actions. This particular device uses a touch-screen so that well-known operations of tapping, swiping, pinching or otherwise touching the screen display act as user inputs to the device. In other embodiments, any suitable type of user input device and/or method may be used. For example, a mouse and pointer, keyboard, voice command, gestures, etc., can be used as input methods. Further, any suitable type of display or other means to present data or information to a user may be employed such as audio, tactile, etc.

FIG. 1A shows a first starting screen that is sometimes referred to as a “home” screen. The white circle 110 is used to illustrate a user press, or tap. The white arrow 112 is used to represent a swipe to the right in the direction of the arrow, respectively. These white symbols are for discussion and illustration only and do not appear on the display of the device when in normal use in a particular embodiment except, optionally, during the editing or training modes described below. Thus, in FIG. 1A, the user has touched the screen at the white circle 110 and has swiped to the right as shown by the white arrow 112. As is known in the art, this causes a second screen to appear as illustrated by FIG. 1B. The second screen is conceptually to the left of the home screen and is shown coming in from the left side to slide or scroll to the right to overlay or replace the home screen. Although specific types of screen layouts, animations, manipulations or other characteristics may be described, these screen characteristics are merely illustrative of a specific device, platform and/or function and can vary with different embodiments and applications.

In FIG. 1B, the user's action of tapping on the “Settings” icon 120 is illustrated. The user's tap is shown by circle 122. This results in the screen of FIG. 1C, showing the selections and operations available from the “Settings” page. In FIG. 1C, the user taps at 130 on the “More . . .” option to bring up the screen of FIG. 1D. From FIG. 1D the user taps on the “Tethering & portable hotspot” option at 140 which produces the screen display of FIG. 1E. In FIG. 1E, the user taps on the “Portable WiFi hotspot” item at 150. This completes the user's input and FIG. 1F shows that a checkmark is displayed at 160 and the text message shows that hotspot is turning on. Finally, in FIG. 1G, the text message explains that the hotspot is active and the operation has completed.

From FIG. 1A-G we see that in order for a user to turn on the hotspot function from the home page requires a swipe and 4 subsequent taps, or 5 distinct actions. After each of these 5 actions a different screen is displayed. Although user interface designers and programmers go to great pains to make the interfaces react as quickly as possible, there are often delays of tenths of a second or more that are very noticeable to a user who might otherwise be able to complete the entire sequence of actions in less than a second. Some of the delays can be due to other code executing in the device, such as operating system functions or applications, that need to use resources such as processor cycles, memory access, network bus access, etc. Delays in reacting to a user's actions can be due to hardware, software (including firmware or other instructions) or to a combination of hardware and software in the user's device or in devices that are interacting with the user's device. In any case, a delay of even tenths of a second can be annoying to a user and can slow the user down in operating the device. Sometimes the user may think the screen is changing and commence with the next action only to press or touch the wrong item on the wrong screen because the screen has not changed yet. Or the user may think that the first action didn't get detected by the device because it is taking longer than expected for the device to react to the action. Other unwanted effects in user operation of the device can be attributed to slow response or reaction by the user interface under the control of the user device.

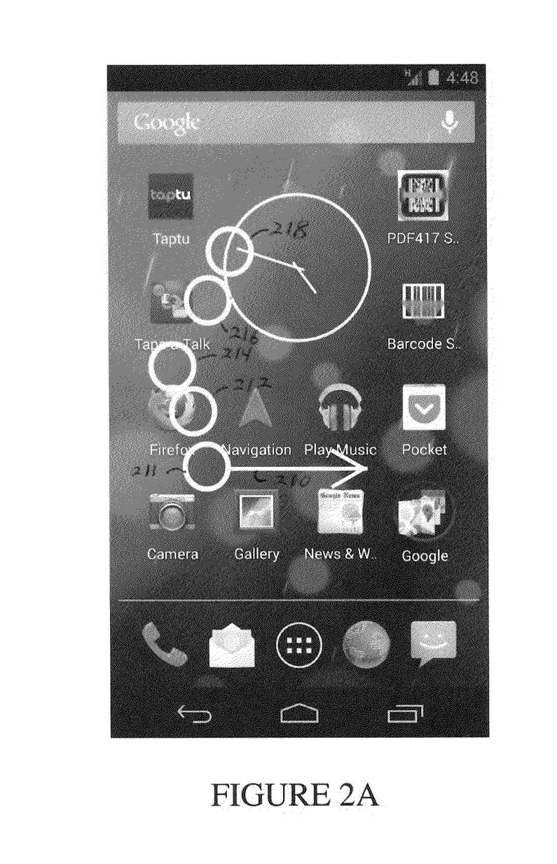

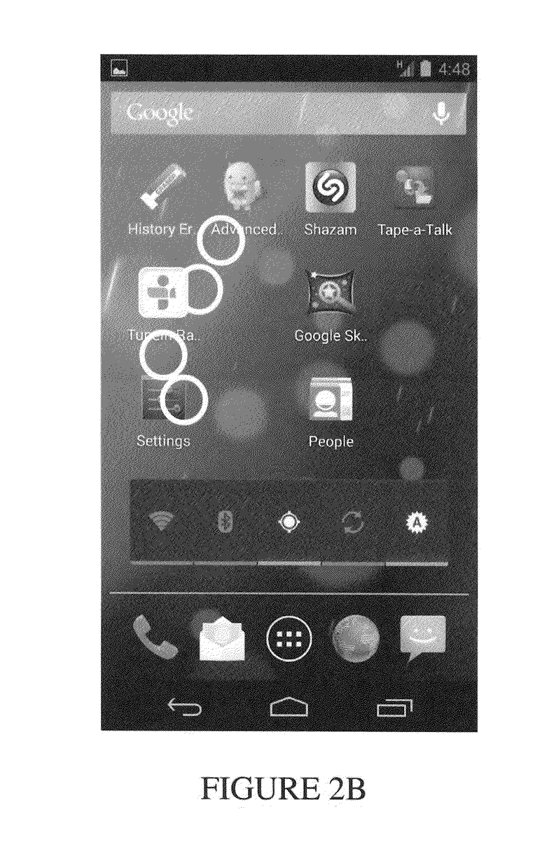

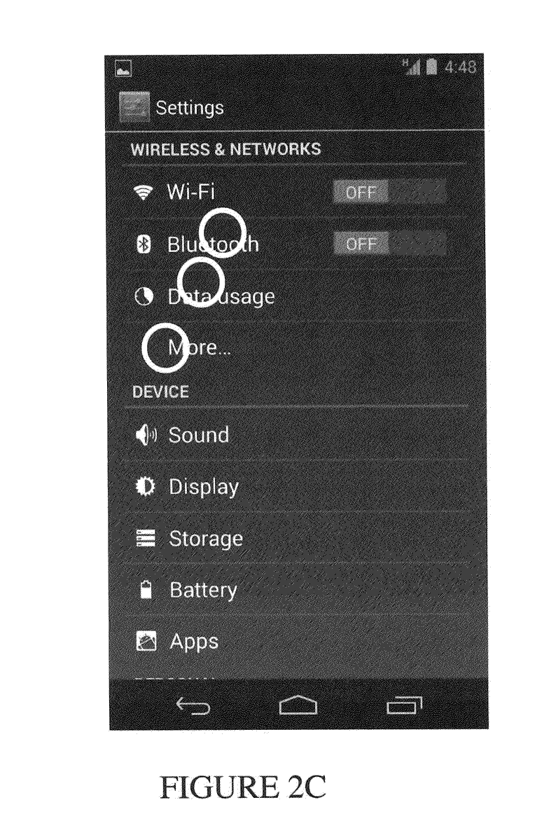

FIG. 2A illustrates all of the above 5 actions on the home or starting screen. Embodiments provide for performing multiple actions on any one or more screens without waiting for a successive or next screen to be displayed in the set of screens used to achieve a function or operation. So, for example, a user can perform all of the taps and swipe to turn on the portable wifi hotspot setting without regard to which screen they are on or how and/or when the screens are changing. This approach can also be described as “tap ahead” or “screen skipping.”

FIG. 2B illustrates the user starting on the second screen, FIG. 1B, in the screen sequence of FIGS. 1A-H. From the screen of FIG. 2B it is no longer necessary to do the first swipe action shown in FIG. 1A since the user is already on the second screen. So the user only needs to do the 4 tap actions from the second screen in order to turn on the portable wifi hotspot function. Similarly, from the screen in FIG. 2C the user need only perform the 3 taps as illustrated in FIG. 2C. As described, the user can perform any of the remaining actions at any of the screens in the set or sequence of screens normally used to perform the function without waiting for a change or update to the current screen. In other embodiments, the actions to invoke a function can be made at any screen regardless of whether the screen is in the set of screens in the standard sequence for that function. As described in more detail, the actions that form a “pattern” to achieve a function or result can be edited in size, shape, sequence, timing, placement, ordering and in other characteristics.

The screen skipping mode can be entered or “triggered” in various ways and the user can be provided with an indication that screen skipping is taking place. One way to trigger the screen skipping mode is to determine that the user has started to perform actions in a manner that would not be done for normal use of the device. For example, if it is determined that two taps have occurred in close time proximity that do not make sense for the current page then the system can determine if the second action is meant to be applied to the options or controls on a subsequent screen that has not yet been displayed. Thus, detection of the second action as intended for a second page could initiate the screen skipping mode.

Applying this trigger example to the screen shown in FIG. 2A, if the system detects the swipe 210 and then the next tap 212 before the second screen (FIG. 2B) has been displayed then the system can assume that the user is trying to tap ahead and the system can enter the screen skipping mode and treat the remaining actions in the known pattern and turn on wifi. The screen skipping mode need not show all intermediate screens in a sequence. For example, if the user performs all of the 5 actions 210-218 shown in FIG. 2A in close time proximity while the screen in FIG. 2A (or, equivalently the screen in FIG. 1A) is being displayed then the system can next display the screen of FIG. 1F immediately. Or the system can remain on the current screen of FIG. 1A and provide an indicator that the portable hotspot is turning on or is activated.

Screen skipping mode can initiate when two actions are performed within a predetermined amount of time. For example, when two or more actions are performed within one half-second. Or when multiple actions have been performed before a screen has had a chance to change and the first action would normally cause a screen change. Screen skipping can exit automatically as, for example, when a predetermined amount of time has gone by without the user entering an action. For example, screen skipping mode can be exited when an action has not been entered within one-quarter, one-half, three-quarters, or one second of the previous action. These time intervals can vary and can be adjusted automatically by hardware or software or set or adjusted by a user.

Other ways to initiate or exit screen skipping mode are possible. For example, a user can depress a hard or soft button or otherwise manipulate a control on the screen or on the device itself. The user can use a voice command, gesture, physical movement (e.g., shaking the device), or combination of input actions. For example, if the user touches the screen to activate an icon or make a menu selection and then makes a lightning bolt trace with their finger then screen skipping can be initiated. The touch and lightning bolt trace serves both to indicate the first action (touching an icon) and that screen skipping is to be initiated.

In one embodiment, when screen skipping is initiated there is a feedback cue or indicator presented to the user. For example, the screen can be displayed in a reddish hue. The device could vibrate. An audible tone or sound effect can be played. The screen or a portion of the screen can animate, such as wiggling. Text or symbols can be displayed. Other types of feedback cues can be used.

In one embodiment, screen skipping includes immediate playback of the screens being skipped. Assuming a standard screen is being displayed by various operating system or application programming interface (API) calls to display each of the various screen objects (icons, buttons, check boxes, menu selections, etc.) and characteristics (color, pattern, animation, font rendering, etc.) the rendering of the screen can take non-negligible time. This is especially true where in order to render the standard, or “active,” screen the operating system or application (or other software/hardware doing the rendering) must wait for information from another process or device before completing rendering. Even where the screen rendering can proceed relatively quickly, it can be prone to interrupts from other processes or hardware that have a higher priority. If the screen rendering is interrupted then the delay until screen rendering resumes can be relatively long and noticeable and inconvenient for a user.

One approach to alleviating or eliminating such screen rendering delays is to capture a bitmap image of the rendered screen and then use the bitmap image in place of the rendered screen. The bitmap image can be obtained from a screen capture and then stored until it is needed for playback during screen skipping. As the rendered screen becomes available it can be used to replace, in whole or in part, the bitmap image. By using bitmap images there is more of a chance that the user can be presented with what looks like the standard screens so that the user can retain the context of navigating within the various screens of the device even during the screen skipping mode.

Embodiments provide an authoring mode and/or interface so that a user can record and edit the action sequence for screen skipping. A button or control can initiate recording or editing. For example, any method as described above for initiating the screen skipping mode can be used to initiate authoring and editing. In a recording mode, the sequence of user actions is recorded as the user invokes a function by navigating among standard screens. Once recorded, the user can enter an editing mode whereby the user can edit the size, shape, sequence, timing and other characteristics of the actions in the sequence. For example, an authoring interface can be as shown as in FIG. 2A where the circles and arrows can be adjusted by using touch, or other, inputs. The user can adjust the circle or “tap area” shapes 211, 212, 214, 216 and 218 by dragging the border (circumference) to adjust the size. The shape can be adjusted by using any convenient interface such as allowing handles for deforming the circle to an oval; allowing selection buttons to transform the circles or other shapes to a square, triangle, circle with swipe arrow, etc. One embodiment allows the user to see the default on-screen area for the displayed item that was the subject of activation. For example, where the user touches the “tethering & portable hotspot” selection in FIG. 1D, the default, or system-provided, shape in the editing mode can be the entire rectangle area that is dedicated to the “tethering & portable hotspot” menu selection text bounded by the two horizontal lines. Note that some actions, such as the swipe action or pinch-to-zoom, are not position dependent and can be defaulted to being performed anywhere on the screen. Other variations are possible.

By allowing the user to adjust the size, shape and placement of the touch areas, the user can modify and customize the action sequence to their particular feel, behavior and/or needs. Thus, actions can be accommodated by larger touch areas. An action's acceptable touch area can overlap with another action's touch area, or be moved to another part of the screen, altogether. Any desirable shape and arrangement of combinations of touch areas are possible.

Users who require more time to remember, or move, in order to perform the actions can set a global interval or individual intervals between actions, as desired. Default screen skip action patterns can be provided by manufacturers of the device, operating system, applications, etc., and the user can edit the default patterns, as desired. Patterns can be stored and transferred as, for example, by allowing a repository of patterns that can be downloaded into a device over a digital network.

A preferred embodiment attempts to model the default action pattern on the actual actions the user goes through with the standard screen renderings (i.e., no screen skipping). This allows the user to learn the screen skipping action sequence without extra effort since the screen skipping actions and sequence are the same as for the standard screens. However, in other embodiments the screen skipping action pattern need not be the same as for the standard screens. The different patterns can be designed by an interface designer, device or operating system developer or manufacturer, modified by the user, or obtained in any suitable manner.

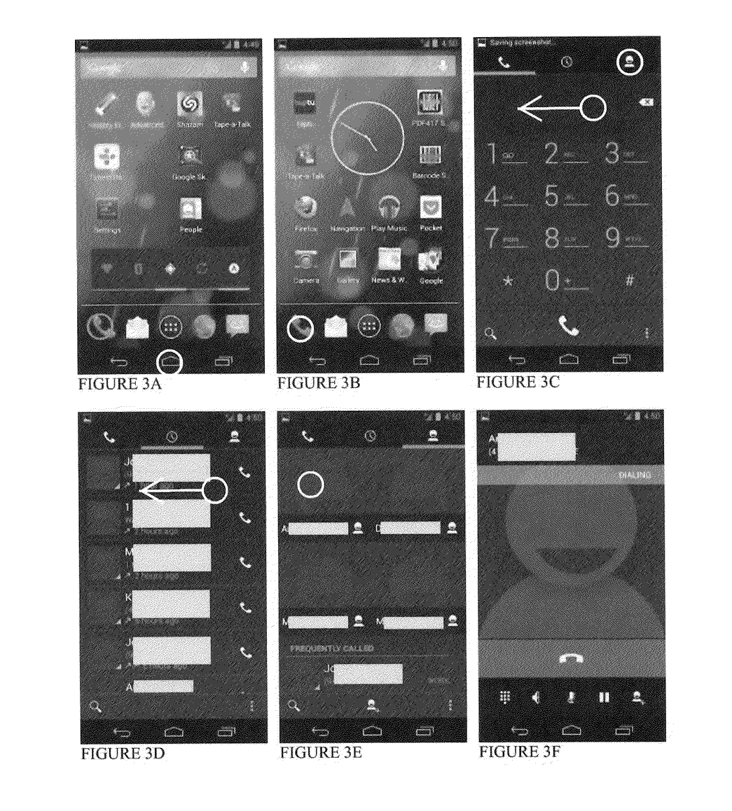

FIGS. 3A-F illustrate another function or use case. In the example of FIGS. 3A-F, a user wishes to dial a person's phone number. The starting screen may be any screen that the device is capable of displaying. Usually, it is useful or necessary in creating an action pattern to start the pattern from a known location. If the user wishes to allow the pattern to be used from any screen then the home button shown in the white circle in FIG. 3A can be pressed. In some operating systems such as Android or iOS there can be a button (hardwired or software) that brings the user to a known screen. In this case the home screen of FIG. 3B is invoked. Since the home button is generally always available on any screen being displayed on the device, using the home screen as a starting point often works well to start an action pattern. Note that the phone button shown in a red circle in FIG. 3A might also be a good candidate for a starting action but it is not always guaranteed that the phone button will be displayed. In some embodiments, multiple different controls or action can be used from or at the same point in a sequence. In other words, the action pattern can be designed so that tapping on the home icon OR the phone icon progresses to the next screen in the sequence.

FIG. 3B shows the second screen in the phone dialing action pattern sequence. On the screen of FIG. 3B the phone icon is tapped as shown in the white circle. Note that the point in the sequence of FIG. 3B to select the phone can be made identical to the point in the sequence of selecting the phone from the screen of FIG. 3A. One reason the user may want to define the pattern sequence as 1st screen tap on home button; 2nd screen tap on phone icon; is that this ensures that it is known that the phone icon will be visible in the screen and position shown in FIG. 3B after the home button shown in FIG. 3A is selected.

FIG. 3C next shows that the user has been placed into the phone dialing application, or panel. The user does not wish to dial a number using the phone's 12-digit keypad. In order to get to the user's favorite contacts screen the user can perform a left swipe as shown by the white circle with arrow to the left; or the user can simply press the favorite contacts icon in the top right corner (encircled by the white circle). As is known in the art, the swipe can occur anywhere on the screen to move the user to the screen to the right of the current screen. In general, some screen dynamic multi-touch actions, such as swipes and pinches, can be performed anywhere on the screen without regard to the icons, controls or graphics that are on the screen.

Assuming the user has swiped to the left from the screen of FIG. 3C, then the user is presented with the screen of FIG. 3D. The screen of FIG. 3D is still not the favorite contacts screen so the user must do another left swipe to get to the favorite contacts screen shown in FIG. 3E. Names and phone numbers and other confidential or personal information has been blocked from the depicted screen displays. Note that the user could more easily have arrived at the favorite contacts screen by using the icon in the top-right of the screen of FIG. 3C or FIG. 3D. In general, the user may use any suitable control, operation or method to arrive at the desired screen. Multiple such methods can be defined in a pattern as alternatives. New or different methods or actions can be defined into the pattern, as desired.

FIG. 3E shows the favorite contacts screen. In this case the user has pre-defined 4 people as frequently called. Each of these 4 contacts is represented in a grid pattern by a square box with a large face graphic. In this pattern, the user desired to call the contact in the top-left of the set of 4 squares. Once the user taps on the desired contact, FIG. 3F shows the screen that is displayed to show that the contact is being called.

The system can have patterns for each of the 4 people in the favorite contacts list. The patterns can be the same except for the final tap which corresponds to the place on the grid where the button or control for that particular favorite contact is located.

If the user wants to dial someone who is not one of the 4 favorite contacts then the action pattern can still be used to get to the favorite contacts page. Whereupon the user can exit screen skip mode (e.g., as by pausing before entering the next action) and then use any of the features provided by the system to find the desired person to call (e.g., name search, scroll through list, etc.). Many other use cases are possible.

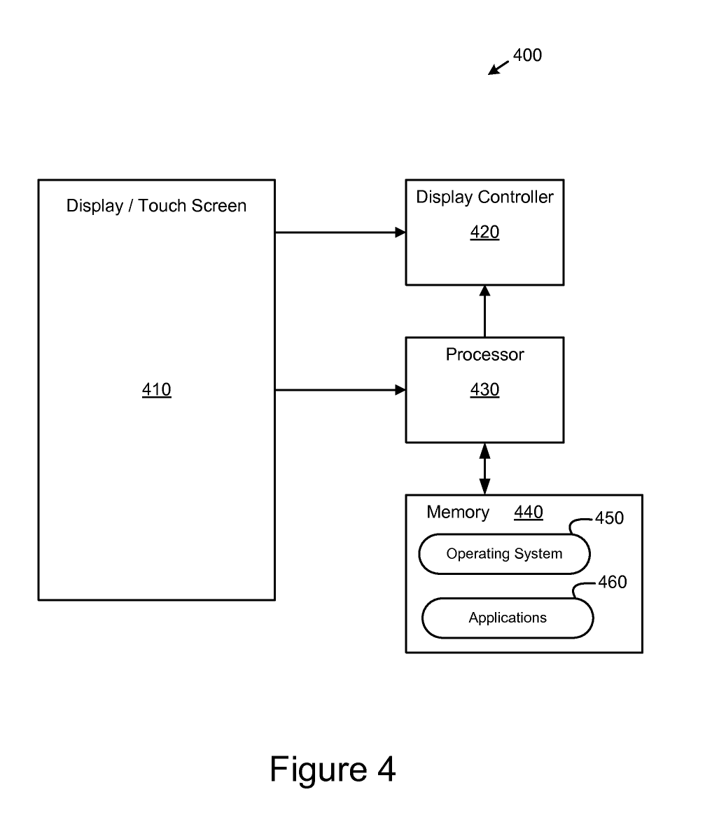

FIG. 4 shows basic hardware that can be used with embodiments of the invention. Note that although specific hardware is described, functions described herein can be adapted for use with many different types and combinations of hardware.

In FIG. 4, user device 400 includes a display screen with integrated, or overlayed, touchscreen, to both display information and accept user touch inputs. In other embodiments, additional or different input/output devices may be used such as physical buttons or other controls, 3d display screens, virtual reality stereo displays, etc. In general, any suitable hardware may be employed.

Display controller 420 converts information provided by processor 430 into electrical signals for activating picture elements on the display screen in a known manner to produce displays, such as the displays referred to in the Figures discussed above. Processor 430 executes instructions provided by memory 440 or other storage devices or sources (e.g., read-only memory, received from a network, etc.). Memory 440 can include operating system instructions and data shown at 450, applications 460 or other sources of instructions and data as is known in the art. FIG. 4 is intended to be a basic diagram and the number and type of modules, interconnections or other properties can vary.

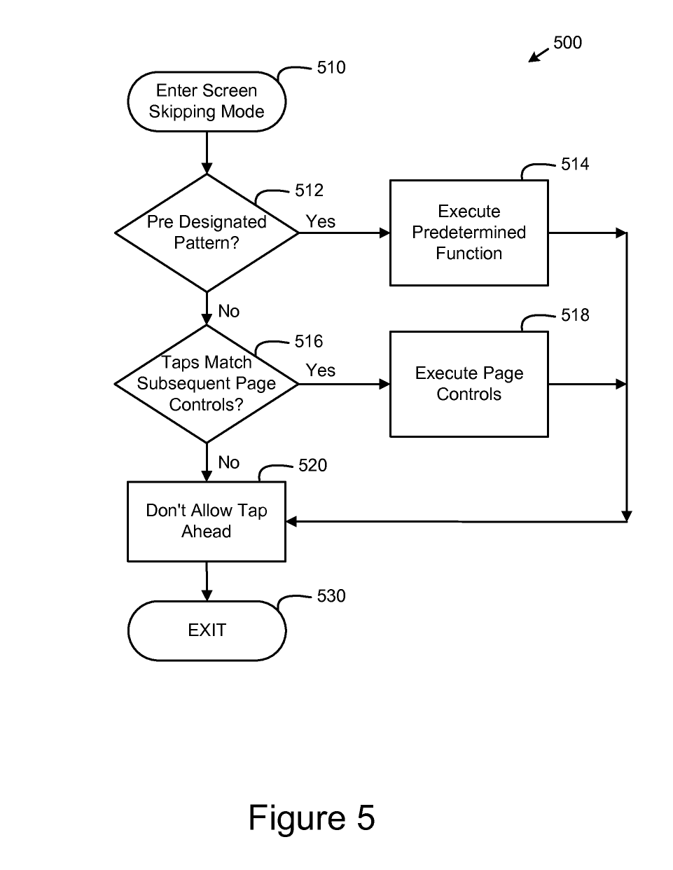

FIG. 5 illustrates basic steps in a procedure to implement features of the embodiments described herein. It should be apparent that the steps of FIG. 5 can be modified in many ways to achieve similar functionality.

At step 510 the routine of FIG. 5 is entered when it is determined that a “screen skipping” mode of operation may be desired. The screen skipping mode can be entered manually by a user control such as shaking the user's device, accepting a pre-designated input signal (tap, swipe, physical button press, etc.), voice command, etc. Or by automatic determination made by hardware and/or software in the device. For example, if a user performs a screen tap very shortly after a first screen tap (or swipe) then the device can enter the screen skipping mode. Another condition could be that the user has made two control inputs where the first was made to change to a different screen and the second input was made before the device had displayed the different screen. Other ways to allow manual or automatic entry into a screen skipping mode are possible.

Once the screen skipping mode is entered, a check is made at 512 as to whether the user inputs are part of a pre-designated pattern. If so, step 514 is performed to execute a predetermined function. As described above, the pattern is preferably the pattern of taps and swipes that the user would normally make in order to invoke a function in a standard manner by waiting for each screen to change. However, in other embodiments, not all of the taps and swipes need be detected before the control function is invoked. After executing the function, the routine exits at step 530.

If, at step 512, no pre-designated pattern is determined then a check is made at step 516 as to whether the control inputs (e.g., taps and swipes) being entered by the user match or correspond with controls on subsequent screens that would be invoked in the normal use (non-screen skipping mode). If so, step 518 is performed to execute the controls on the subsequent pages that correspond to the control inputs being made by the user, even though the user may be making the control inputs on a current screen before the screen with the intended control is displayed. As described above, the subsequent screens do not need to ever be displayed in order for the function corresponding to the page controls to be invoked. Or bitmap images of the page can be quickly displayed. Or other feedback to the user can be provided. The routine then exits at step 530.

If at step 516 there is no determination that the user's control inputs correspond with subsequent page controls, there is no tap ahead control invoked and the routine exits at step 530.

Although the description has been described with respect to particular embodiments thereof, these particular embodiments are merely illustrative, and not restrictive. For example, once an action pattern has been obtained or generated, the user can modify the pattern as desired so that the pattern may not resemble or have much (or anything) in common with the original pattern. The action pattern can be changed or substituted so that other actions such as touch, swipe, gesture or other actions are substituted for actions or components of the action pattern, in whole or in part.

Any suitable programming language may be used to implement the routines of particular embodiments including C, C++, Java, assembly language, etc. Different programming techniques may be employed such as procedural or object-oriented. The routines may execute on a single processing device or on multiple processors. Although the steps, operations, or computations may be presented in a specific order, the order may be changed in particular embodiments. In some particular embodiments, multiple steps shown as sequential in this specification may be performed at the same time. Various features described herein may be combined with other features and/or function on their own, independently of other features that may be described in concert or tandem. In general, variations on features described herein are possible and can be within the scope of the claimed embodiments.

Particular embodiments may be implemented in a computer-readable storage medium (also referred to as a machine-readable storage medium) for use by or in connection with an instruction execution system, apparatus, system, or device. Particular embodiments may be implemented in the form of control logic in software or hardware or a combination of both. The control logic, when executed by one or more processors, may be operable to perform that which is described in particular embodiments.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real time,” “offline,” in a “batch mode,” etc. Portions of processing may be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms. In general, the functions of particular embodiments may be achieved by any means known in the art. Distributed, networked systems, components, and/or circuits may be used. Communication or transfer of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that is stored in a machine-readable medium to permit a computer to perform any of the methods described above.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

While one or more implementations have been described by way of example and in terms of the specific embodiments, it is to be understood that the implementations are not limited to the disclosed embodiments. To the contrary, they are intended to cover various modifications and similar arrangements as would be apparent to those skilled in the art. Therefore, the scope of the appended claims should be accorded the broadest interpretation so as to encompass all such modifications and similar arrangements.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A method for providing a graphical user interface on a device, the method comprising:
rendering a first screen on the device, wherein the first screen includes a first option, wherein selecting the option in a normal mode of operation causes the device to render a second display screen, wherein the second display screen includes a second option, wherein the second option corresponds to a function;
selecting a second non-normal mode of operation; accepting a first user input to select the first option; skipping rendering of the second display screen;
detecting a second user input that would have selected the second option on the second display screen had the second display screen been rendered; and
performing the function in response to the second user input.

2. A method for controlling a device, the method comprising:
recording two or more user inputs to create an action pattern;
associating a function with the created action pattern; and
determining when at least a portion of the created action pattern is being entered by a user; and
performing the function in response to the determining.

3. The method of claim 2, wherein the action pattern includes a plurality of actions, the method further comprising:
editing the action pattern to provide a modified action pattern; and
using the modified action pattern in place of the created action pattern.

4. The method of claim 3, wherein editing includes:
deleting an action.

5. The method of claim 3, wherein editing includes:
changing an action.

6. The method of claim 1, wherein the device includes a display and a touch screen coupled to one or more processors.

7. An apparatus comprising:
one or more processors;
a processor-readable tangible medium including one or more instructions executable by the processor for providing a graphical user interface on a device, the processor-readable tangible medium including one or more instructions for:
rendering a first screen on the device, wherein the first screen includes a first option, wherein selecting the option in a normal mode of operation causes the device to render a second display screen, wherein the second display screen includes a second option, wherein the second option corresponds to a function;
selecting a second non-normal mode of operation; accepting a first user input to select the first option; skipping rendering of the second display screen;
detecting a second user input that would have selected the second option on the second display screen had the second display screen been rendered; and
performing the function in response to the second user input.
